(19) United States
(12) Patent Application Publication
(10) Pub. No.: US 2024/0001180 A1
(43) Pub. Date: Jan. 4, 2024

(54) Smoke Seal

(71) Applicant: Coopers Fire Limited, Hampshire (GB)

(72) Inventor: Robert Wright, Hampshire (GB)

(21) Appl. No.: 18/215,359

(22) Filed: Jun. 28, 2023

(30) Foreign Application Priority Data
Jun. 29, 2022 (EP) 22182050.9

(51) Int. Cl. A62C 2/10; E06B 9/17

(52) U.S. Cl. CPC A62C 2/10; E06B 9/17076

(57) ABSTRACT

A side guide for a smoke or fire curtain comprises:
a pair of sides defining a channel and having in-turning lips at one end defining an opening; and
at least one strip of a fire-proof material extending from at least one side and directed towards a centre of the channel, extending the length of the side and of a width to contact a curtain deployed between the sides,
   wherein when the curtain is deployed in the side guide the strip contacts the curtain and forms a barrier to passage of smoke through the side guide, and
   wherein the strip is arranged such that on contact with the curtain at least a portion of the strip is directed away from the opening and the strip does not pass through the lips.

### CROSS REFERENCE TO RELATED APPLICATION

This application claims the benefit and take priority of European Patent No. 22182050.9, filed on Jun. 29, 2022, the contents of which are herein incorporated by reference in its entirety as part of the present application.

### INTRODUCTION

The present invention relates to a smoke seal to prevent smoke from passing around the edges of a curtain, in particular a fire curtain, a smoke curtain or a fire and smoke curtain.

### BACKGROUND TO THE INVENTION

Smoke curtains are used primarily to channel smoke to a suitable vent, for example in a wall or roof. Such curtains may, once deployed, extend all the way from ceiling to floor, or just part of the way to the floor.

Fire or fire and smoke curtain are used to block the passage of fire and smoke from one area into another, stopping or slowing the spread of the fire, and additionally may be used to channel smoke to a suitable exit or vent. Such curtains can be used to block an entrance, for example into a room or space.

A curtain on a roller may be provided, with edges of the curtain being contained within side guides. Equally, the curtain may be provided in concertina form, again with edges of the curtain being contained within side guides. While the curtain prevents or significantly reduces the flow of smoke through the opening, a known issue is that it is usually possible for at least some smoke to flow through the side guides and thus still enter the room or space. Equally it is known that smoke can pass over or around the curtain roll or concertina support, which are generally provided in a head box. This applies to smoke curtains, fire curtains and fire and smoke curtains.

Various attempts have been made to create seals for preventing smoke from passing through a side guide. Side guides are often generally C-shaped channels, albeit with straight rather than curved sides, and with in-turned lips. Edge formations on the smoke and/or fire curtains prevent removal of the curtain from the narrowed entrance to the side guide.

In some attempts to provide a smoke seal nylon brush formations have been attached on the inside of the side guide to form a partial seal, preventing or further significantly reducing the passage of smoke through the side guide. In other cases, formations have been added to the edge formations of the smoke curtain to contact the side guides, again with the aim of forming a seal, seen for example in WO 2021/245421.

However, none of these attempts have fully solved the problem of smoke passage through the side guides. While nylon brush formations are effective at low temperatures, such brushes melt at approximately 200° C. and thus are no longer effective above these temperatures. As the temperature of a fire in a building will typically exceed this temperature, such seals do not offer much protection against smoke passage. Similarly, formations, such as flaps, positioned on the edge formations of the curtains can melt at elevated temperatures, and additionally, the movement of the curtain within the side guides e.g., under smoke/fire pressure can disengage the flaps from the side guides, allowing smoke to pass.

While ensuring smoke does not pass through a side guide or headbox is particularly important for smoke curtains, it is also very relevant to fire curtains, and of course to fire and smoke curtains. Thus, there is a need for a smoke seal that prevents, or essentially prevents, smoke passage through the side guide and/or headbox.

An object of the invention is to prevent passage of smoke through a side guide and/or headbox of a smoke and/or fire curtain.

### SUMMARY OF THE INVENTION

According to the invention there is provided a smoke seal for a smoke, smoke and fire, or fire curtain comprising:
a pair of sides defining a channel and having in-turning lips at one end defining an opening and
at least one strip of fire-proof material extending from at least one side and directed towards a centre of the channel, the strip extending the length of the side and of a width to contact a curtain deployed between the sides,
   wherein when the curtain is deployed in the side guide the strip contacts the curtain and forms a barrier to passage of smoke through the side guide, and
   wherein the strip is arranged such that on contact with the curtain at least a portion of the strip is directed away from the opening and the strip does not pass through the lips.

In use, when a fire, fire and smoke or smoke curtain passes between the sides, the strip of fire-proof material lies thereagainst, preventing the passage of smoke around the curtain.

Due to the flexibility of the strip, contact will be maintained with the curtain even when there is some movement of the curtain, for example as a result of fire pressure. Equally, as the strip is made from a fire-proof material the strip will not fail at temperatures at which the fire, fire and smoke or smoke curtain does not fail.

The strip is generally resilient yet flexible and angled so that it engages the deployed curtain and is urged into contact with the curtain material, forming a seal. At the point of contact with the curtain the strip bends into line with the curtain and makes contact with the curtain over at least a portion of the strip, usually an edge portion, forming the seal.

The length of the strip is essentially that of the channel, although the strip may not extend the full length of the channel if, for example, the channel extends into a floor. The width of the strip is sufficient to contact a curtain between the sides of the channel and maintain contact therewith and thus may be approximately 70-150% of the distance between the sides, preferably 80-140%, and most preferably 80-120% of the distance between the sides.

The channel may be used as a side guide for extending down the sides of the curtain when deployed. When used as a side guide, the channel will typically include a back connecting the sides at an opposite end from the opening.

Alternatively, the channel may be used to form a seal in the head box and thus extend along the width of the curtain. Here no back will be provided to enable the curtain the extend therethrough on deployment.

The strip may be in the form of a single strip, a double strip, i.e., two strips, or may be doubled back on itself to produce a loop. Where the strip is in the form of a loop, both ends may be secured to the side. Usually, the width of the strip used to form a loop will be at least substantially twice the width of a single strip, so that when it is doubled back the width of the loop is the same as that of a single strip. It has been found that as fireproof material is a thick and strong material, often incorporating woven metal, it is resistant to folding and particularly forming a folded, shape edge. Consequently, such material retains a loop formation even when pressed upon. When used in this arrangement, the width of the strip will generally be between approximately 140-400% of the distance between the sides, preferably 150-300%, and most preferably 180-200% of the distance between the sides.

While a single strip extending from one side will be sufficient to prevent, or at least significantly reduce smoke passage around a curtain, usually strips are provided extending from each side.

The smoke seal may be part of an assembly comprising:
a roller for deployment and withdrawal of a smoke or fire curtain;
a fire or smoke curtain wound onto the roller; and
a pair of side guide comprising the smoke seal of the first aspect further incorporating a back connecting the sides opposite to the opening.

Edges of the curtain are suitably provided with means for retaining the curtain in the side guides. Typically, the retaining means may be studs. Usefully, these may include projections sized so as not to pass through an opening formed between the guide lips.

In use, the curtain is retained within the pair of side guides, and the strips are pressed into contact with the curtain, preventing the passage of smoke through the side guides. While one strip may be provided from one side of the side guide, usually each side guide will be provided with a pair of strips, one extending from each side thereof, and angled towards each other and towards the opening. For each side guide, it is thus preferred there is a pair of strips, angled together and overlapping with each other along the line of the curtain when deployed. The strip is pressed onto the curtain on each side, forming a seal along each side of the curtain and providing back-up sealing compared with using just single strip on one side only. Where the strip is provided as a loop, the loop may provide a stronger force against the curtain,

Strip material is suitably flexible, resilient and fire-proof and can be made of conventional materials meeting this specification.

Advantageously, the or each strip may be made of the same material as the curtain, namely a fire proof material having resilience.

The strips may be provided as a single strip, two strips or may be turned back to itself to form a loop.

Usually, the side guide will have a straight back, a pair of opposing sides, a pair of front members angled into the side guide and towards each other, leaving a small gap (or opening) therebetween for passage of the curtain, and extension portions turned into towards the opposing sides.

The strips may be provided with additional stiffening, to allow them to flex but return to their original shape to ensure contact with the curtain when deployed.

Typically, the strip will be sealingly attached to the side guide, e.g., by rivets, but may be attached by screws, or other fitting means that will be slow to melt of fail in the heat of a fire.

Conveniently, carriers may be provided within the guide to hold an end or ends of the or each strip. The carrier may additionally support extension portions or lips of the sides.

Generally, the side guide will be made from steel, but may alternatively be made from aluminium. Typically, the or each carrier may be made from aluminium.

Side guides are usually provided having sides having a depth greater that their width. This allows for more than a minimum width of curtain to be contained within the side guide and to allow for any misalignment resulting from imperfect rolling to be accommodated without damaging the curtain.

The provision of one or more strips facing away from the lips provides additional contact between the strip(s) and the curtain, providing an improved seal. This is the case whether the curtain is central between a pair of side guides, or not.

Preferably, the strip(s) are attached to the sides adjacent the lips, providing the longest possible contact between the strip(s) and the curtain.

Preferably, the assembly usually further comprises a headbox holding the roller from which the curtain can be unrolled for deployment and re-rolled for storage and having an opening through which the curtain passes.

In some embodiments, a headbox may be provided incorporating the smoke seal of the invention, and the side guides may include no smoke seal or a smoke seal of a different type.

The head box may advantageously contain a further smoke seal, within the head box and above the opening, to prevent smoke from passing through the head box. The smoke seal may comprise:
a pair of sides defining a channel and having in-turning lips at one end defining an opening; and
at least one strip of fire-proof material extending from at least one side and directed towards the opening, the strip extending the length of the side.

As the curtain will pass though the channel, no back will be provided.

While one strip may be provided from one side of the channel, usually each side will be provided with a strip, one extending from each side thereof, and angled towards each other and towards the opening. It is thus preferred to provide a pair of strips, angled together and overlapping with each other along the line of the curtain when deployed. The strip is pressed onto the curtain on each side, forming a seal along each side of the curtain and providing back-up sealing compared with using just single strip on one side only.

Strip material is suitably flexible, resilient and fire-proof and can be made of conventional materials meeting this specification.

Advantageously, the or each strip may be made of the same material as the curtain, namely a fire proof material having resilience and some flexibility.

The strip may be a single strip, two strips or a single piece folded around and back on itself to form a loop.

The strips may be provided with additional stiffening, to allow them to flex but return to their original shape to ensure contact with the curtain when deployed. However, this is usually found to be unnecessary.

Typically, the strip will be sealingly attached to the side guide, e.g., by rivets, but may be attached by screws, or other fitting means.

Conveniently, carriers may be provided within the seal hold an end of the or each strip. The carrier may additionally support extension portions of the side guides. Typically, such carried may be made of extruded aluminium securable to the or each side of the seal, having an indentation into which the strip can be secured. For example, the strip may be secured with grub screws. While the strip may be continuously secured into the channel, there may be a distance between securing point. Generally, with the distance between securing points may be 200-400 mm, preferably 250-350 mm.

Advantageously, the side guides can be connected to the smoke seal in the headbox creating a seal on three edges of the curtain. Thus, the sides of the side guides can be connected to the sides of the headbox smoke seal. The seal can be one long section, bent between the side guides and headbox smoke seal, having a back when a side guide and not back when a headbox smoke seal. Alternatively, the sides of the side guides may be welded to the side of the headbox smoke seal. The fourth edge, when deployed being the ground, with the weight of the curtain, and/or a bottom bar forming a seal.

While usually an arrangement for a smoke curtain, a smoke and fire curtain or a fire curtain, will include a smoke seal in the sides guides and in the head box, some arrangement may include a smoke seal in the side guides but not in the headbox, and in other a smoke seal may be provided in the headbox but not in the side guides.

Equally, the arrangement of the strip will not necessarily be the same in both the side guides and headbox (even when provided in both). For example, the strip may be used as a single layer in the side guides, while may be provided in the form of a loop in the headbox, and equally may be provided as a loop in the side guides and a single layer in the headbox.

### DETAILED DESCRIPTION OF THE INVENTION

To help understanding of the invention, a specific embodiment thereof will now be described by way of example and with reference to the accompanying drawings, in which:—

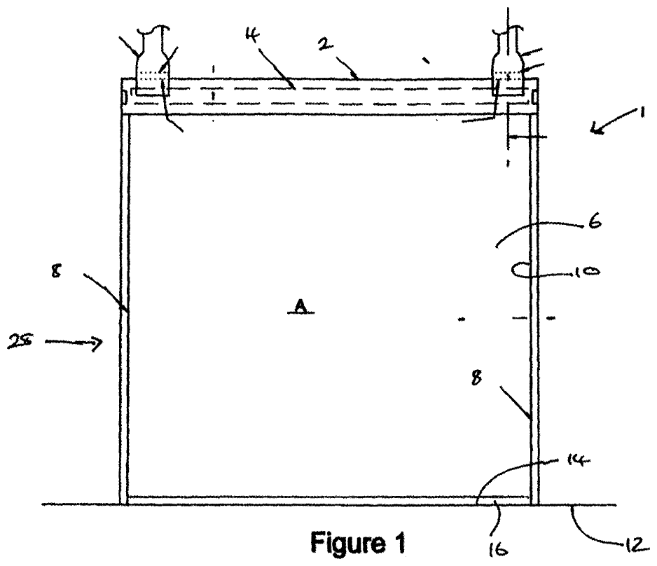

FIG. 1 is a front view of a fire curtain arrangement having side guides along each vertical side;

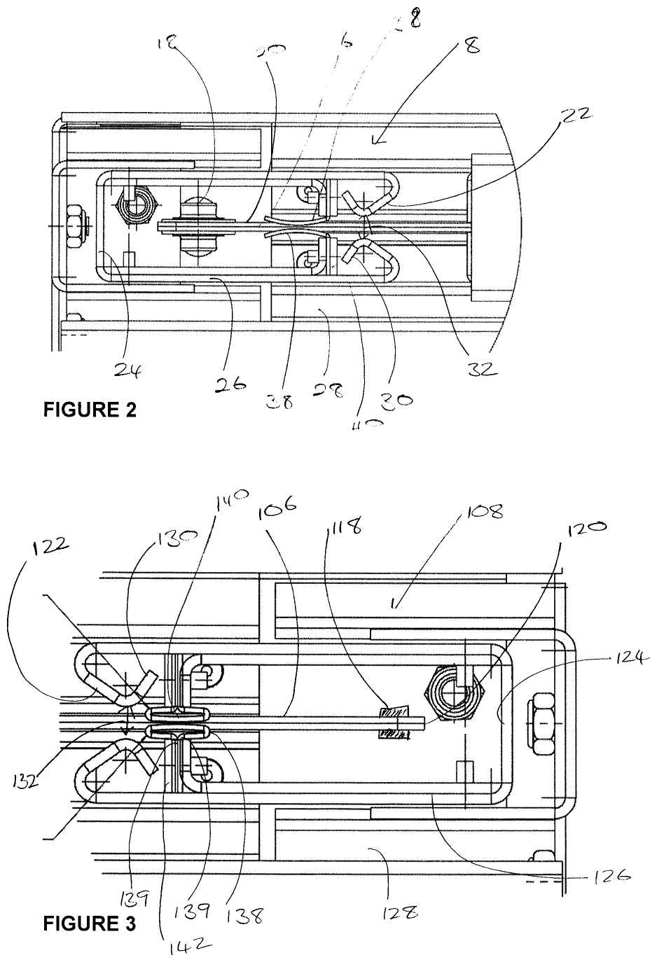

FIG. 2 is a cross-section of the left-hand side guide of the arrangement of FIG. 1 including a smoke seal in accordance with the invention; and

FIG. 3 is a cross-section of an alternative side guide according to FIG. 1, including an alternative smoke seal in accordance with the invention;

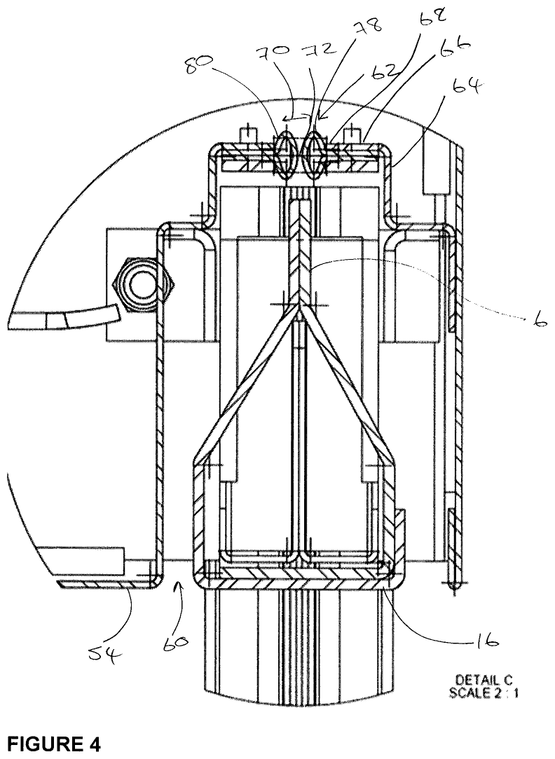

FIG. 4 shows a smoke seal in accordance with the invention in the headbox of FIG. 1.

FIG. 1 shows a smoke or fire barrier 1, comprising a head box 2 containing a roller 4 holding a curtain 6.

Extending down from the head box 2 are a pair of side guides 8 which each provide a vertical channel to guide edges 10 of the curtain 6 down from the roller 4 when deployed to or towards the floor. The side guides 8 extend the length of the deployment of the curtain 6, as shown to the floor 12.

The bottom 14 of the curtain 6 is provided with a bottom bar 16 for weighting the curtain 6 easing deployment and resisting movement of the curtain when deployed. The bottom bar 16 also provides a closure to the headbox 2.

The curtain 6 is provided with formations 18 along its edges 20 for retention in the side guides 8. The formations may be studs, but other elements can be used.

Details of the side guides are shown more clearly in FIGS. 2 and 3, in which two embodiments of the smoke guide according to the invention are set out.

Turning initially to FIG. 2, the side guide 8 thereshown is of general C-shaped cross section, with in-turned lips 22 forming entrance or opening 32. The sides guide 8 each have a back 24 and sides 26 and are generally contained within a wall 28. The in-turned lips 22 are angled into the side guide 8 and toward each other, and have extensions 30, turned back towards the respective side wall 26. This creates a narrow entrance 32 to the side guide, with the entrance 32 sized to prevent the edges 20 of the curtain 6, and in particular the formations 18, from exiting the side guides 8, while providing sufficient opening for unimpeded passage of the curtain 6. The arrangement of the curtain, guide, roller etc as so far described is conventional in this field.

To prevent smoke from passing around the edges of the curtain through the side guides 8, a sealing strip 38 of resilient, fire-proof material is attached to each side 26 of the side guides 8, the strips being angled towards each other, and on meeting are directed away from the opening 36 towards the back 24. The strips meet at a central point, and thus along a central line where the curtain is anticipated to hang down when deployed. The strips press against each other when there is no curtain and onto respective sides of the curtain when the curtain is deployed. The length of the strip is essentially that of the side guide, and the width of the strip as show is approximately the distance between the sides 26 of the side guides 8. However, the width of the strip may be between approximately 70 and 150% of the distance between the sides.

As can be seen, the side guide has a great depth than width, i.e., the sides 26 are longer than the back 24. This provides enables more than the minimum width of curtain 6 to be held therein. This allows for any misalignment of the curtain, for example due to imperfect rolling, to be accommodated, without damage to the curtain. In addition, it allows for greater possible contact between the strip(s) and the curtain, thus provided a better quality of sealing.

This arrangement ensures that the strips 38 remain in contact with the curtain 6 when deployed, even when there is sideways movement in the curtain, for example as a result of asymmetric fire pressure as well as movement while the curtain is in the process of being deployed. The contact between the strips 38 and the curtain ensures that smoke cannot pass around the edges 20 of the curtain 6 though the side guides.

While one strip on one side of the side guide will be sufficient to prevent smoke passage, usually strips are provided on each side, as shown in FIG. 2.

The strip is attached to a carrier 40 held on the side 26 of the side guide 8.

The curtain 6 may be made from any fireproof material, such as EFP2/1000S material available from Coopers Fires Limited, of Waterlooville, Hampshire, UK. The strips 38 are also made of this same material, although they may be made of an alternative fire-proof material. A double layer of the material may be used to form the strips 38, although the flexibility of a single layer is advantageous in maintaining contact between the strip and the curtain even when there is movement in the curtain due to fire pressure or other air movements in the vicinity.

FIG. 3 shows and alternative arrangement for the smoke seal to that shown in FIG. 2. Again, the side guide 108 thereshown is of general C-shaped cross section, with in-turned lips 122 forming entrance or opening 132. The sides guide 8 each have a back 124 and sides 126 and are generally contained within a wall 228. The in-turned lips 122 are angled into the side guide 108 and toward each other, and have extensions 130, turned back towards the respective side wall 126. This creates a narrow entrance 132 to the side guide, with the entrance 132 sized to prevent the edges 120 of the curtain 106, and in particular the formations 118, from exiting the side guides 108, while providing sufficient opening for unimpeded passage of the curtain 106. As above, the arrangement of the curtain, guide, roller etc as so far described is conventional in this field.

To prevent smoke from passing around the edges of the curtain through the side guides 108, a sealing strip 138 of resilient, fire-proof material is attached to each side 126 of the side guides 108, the strips being looped so that both ends 139 of the strips 139 are held together, with the loop 140 thereby created being directed across the width of the guide. The loops 140 meet at a central point within the guide, and thus along a central line where the curtain is anticipated to hang down when deployed. The strips press against each other when there is no curtain and onto respective sides of the curtain when the curtain is deployed. The length of the strip is essentially that of the side guide, and the width of the strip as show is approximately the distance between the sides 126 of the side guides 108. However, the width of the strip may be between approximately 140-300% of the distance between the sides to ensure that there is good contact between the loop and the curtain when deployed.

This arrangement ensures that the strips 138 and loops 140 remain in contact with the curtain 106 when deployed, even when there is sideways movement in the curtain, for example as a result of asymmetric fire pressure as well as movement while the curtain is in the process of being deployed. The contact between the strips 38 and the curtain ensures that smoke cannot pass around the edges 120 of the curtain 106 though the side guides.

While one strip on one side of the side guide will be sufficient to prevent smoke passage, usually strips are provided on each side, as shown in the FIG. 3.

The strip is attached to a carrier 142 held on the side 126 of the side guide 108.

Turning now to FIG. 4 which shows the sealing arrangement in the headbox 2. The headbox 2 contains the curtain 6 on a roller (not shown) when not deployed and from which the curtain is unrolled for deployment. The headbox includes a bottom 54 having an opening 60 through which the curtain is deployed, and which is closed with the bottom bar 16 when the curtain 6 is rolled for storage.

Above the opening, is provided a smoke seal 62 of the invention, comprising a pair of sides 64 having in turned lips 66 on their inner ends 68—creating a narrowed entrance 70 to the channel 72 between the sides 64. Extending from each lip 66 is a strip of material 78. As shown, the strip 78 has been rolled back on itself to form a loop 80 (as described in reference to FIG. 3). The strips 78 are sized to press against the curtain 6 which hangs therebetween, forming a seal and preventing passage of smooth through the seal.

Typically, the strip 78 is made of the same material as the fire curtain 6. This material is a fire-resistance or fire-proof material and thus is thick for a fabric and typically contains some woven metal. As a result, it is resistance to forming sharp edges or creases when folded. Consequently, the curtain retains the loop 80 formation even when urged against the curtain.

The loop 80 formation may provide better contact with the curtain 6 in use and thus a better seal, and may be urged more strongly against the curtain.

The width of the loop 80 will be approximately twice the width of the strip 38 to approximately twice the distance between the sides 56 of the guide. However, they may be approximately 140-300% of distance between the sides.

The embodiment as shown provides the strips 78 in the form of loops 80. However, the strips 78 may also be provided not looped, but as a strip as shown in FIG. 2 when used in the headbox.

The application is not intended to be limited to the details of the above embodiment.

For example, a strip can be provided on one side of the side guide only. In addition, the side guides can be used with other forms of curtain having other deployment means, for example with folded or concertina curtains.

1. A smoke seal for a smoke or fire curtain comprising:—
a pair of sides defining a channel and having in-turning lips at one end defining an opening; and
at least one strip of fire-proof material extending from at least one side and directed towards a centre of the channel, the strip extending the length of the side and of a width to contact a curtain deployed between the sides,
wherein when the curtain is deployed in the side guide the strip contacts the curtain and forms a barrier to passage of smoke through the side guide, and
wherein the strip is arranged such that on contact with the curtain at least a portion of the strip is directed away from the opening and the strip does not pass through the lips.

2. A smoke seal according to claim 1, wherein the strip extends the whole length of the side guides.

3. A smoke seal according to claim 1, wherein the strip can flex to maintain contact with the curtain when the curtain moves sideways within the guide.

4. A smoke seal according to claim 1, wherein the strip is resilient and angled towards the curtain so that it engages the deployed curtain and is urged into contact with curtain material, forming a seal.

5. A smoke seal according to claim 1, wherein the width of each strip is approximately 70-150% of a distance between the sides.

6. A smoke seal according to claim 1, wherein the strip is rolled back on itself to form a loop, which in use contacts a deployed curtain.

7. A smoke seal according to claim 5, wherein the width of each strip is approximately 140-300% of the distance between the sides.

8. A smoke seal according to claim 1, further comprising a carrier for holding the strip.

9. A smoke seal according to claim 1, including two strips, one attached and extending from each side.

10. A smoke seal according to claim 9, wherein the pair of strips are in contact with each other when the curtain is not deployed.

11. A smoke, smoke and fire or fire curtain assembly comprising:
a smoke, smoke and fire, or fire curtain;
a roller supporting the curtain and for deployment and withdrawal of the smoke or fire curtain; and
a pair of side guides for engaging and retaining edges of the curtain, each side guide comprising a smoke seal according to any one of claims 1-10, the sides being joined at the other end by a back.

12. An assembly according to claim 11, further comprising a headbox holding the roller and curtain, the headbox having a front, back, two ends, a top, and a bottom having an opening though which the curtain can be deployed and returned, the headbox further comprising a smoke seal according to any one of claims 1-9 positioned above the opening in the bottom.

13. An assembly according to claim 11, wherein the strip(s) is made of the same fabric from which the curtain is made.

14. An assembly according to claim 11, wherein the sides of the smoke seals of the side guides and headbox are continuous or joined.

15. An assembly according to claim 11, wherein the strips of the smoke seals of the side guides and headbox are continuous or joined.
